(19) United States
(12) Patent Application Publication
(10) Pub. No.: US 2010/0294517 A1
(43) Pub. Date: Nov. 25, 2010

(54) MOLD FOR AN EQUINE HOOF AND METHOD OF MAKING AND ATTACHING AN IN SITU HORSESHOE AND HOOF PROTECTION

(76) Inventor: Derek Arthur Poupard, Bournemouth (GB)

Correspondence Address: MICHAEL RIES, 318 PARKER PLACE, OSWEGO, IL, 60543, US

(21) Appl. No.: 12/784,635

(22) Filed: May 21, 2010

Related U.S. Application Data
(60) Provisional application No. 61/180,425, filed on May 21, 2009.
(60) Provisional application No. 61/186,909, filed on Jun. 15, 2009.

(51) Int. Cl. A01L 7/00

(52) U.S. Cl. 168/12

(57) ABSTRACT

The present invention is a flexible one-piece horseshoe plastic mold for an equine animal with an equine hoof to make an in situ horseshoe and hoof protection. The mold has a base mold with a cavity area to accommodate the equine hoof with a base and a fast setting material injected into the cavity area through a plurality of holes when the equine hoof is placed in the cavity area forming the horseshoe and hoof protection after an increment of time while the injected material cures and sets while the hoof is placed in the cavity. The present invention also includes a method of making and attaching an in situ horseshoe and hoof protection to an equine to accommodate an equine hoof utilizing a mold.

This application claims priority to U.S. Provisional Application 61/180,425 filed on May 21, 2009 and U.S. Provisional Application 61/186,909 filed on Jun. 15, 2009, the entire disclosure of which is incorporated by reference.

### TECHNICAL FIELD & BACKGROUND

The present invention generally relates to a mold for an equine and an equine hoof and method of making a horseshoe and hoof protection. More specifically, the invention is a horseshoe or other hoof protection mold for an equine and an equine hoof and method of making an in situ horseshoe and hoof protection.

It is an object of the invention to provide a horseshoe or other hoof protection mold to attach a horseshoe or other hoof protection to an equine's hoof without the use of nails or adhesives.

It is an object of the invention to provide a horseshoe or other hoof protection mold that produces an attached horseshoe or hoof protection that is lighter and more flexible than traditional steel or aluminum horseshoes.

What is really needed is a mold that can directly apply a horseshoe or other hoof protection to an equine and equine's hoof and a method of making an in situ horseshoe and hoof protection without the use of nails or adhesives with an attached horseshoe or hoof protection that is lighter and more flexible than traditional steel or aluminum horseshoes.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates an environmental side perspective view of an equine wearing a horseshoe and hoof protection, in accordance with one embodiment of the present invention.

FIG. 2 illustrates a top front perspective view of a mold for an equine animal with an equine hoof to make an in situ horseshoe and hoof protection, in accordance with one embodiment of the present invention.

FIG. 3 illustrates a side environmental perspective view of material being injected into a base mold for an equine animal with an equine hoof to make an in situ horseshoe and hoof protection, in accordance with one embodiment of the present invention.

FIGS. 4A and 4B illustrate a flow chart of the method steps for making and attaching an in situ horseshoe and hoof protection to an equine, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention, however, the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

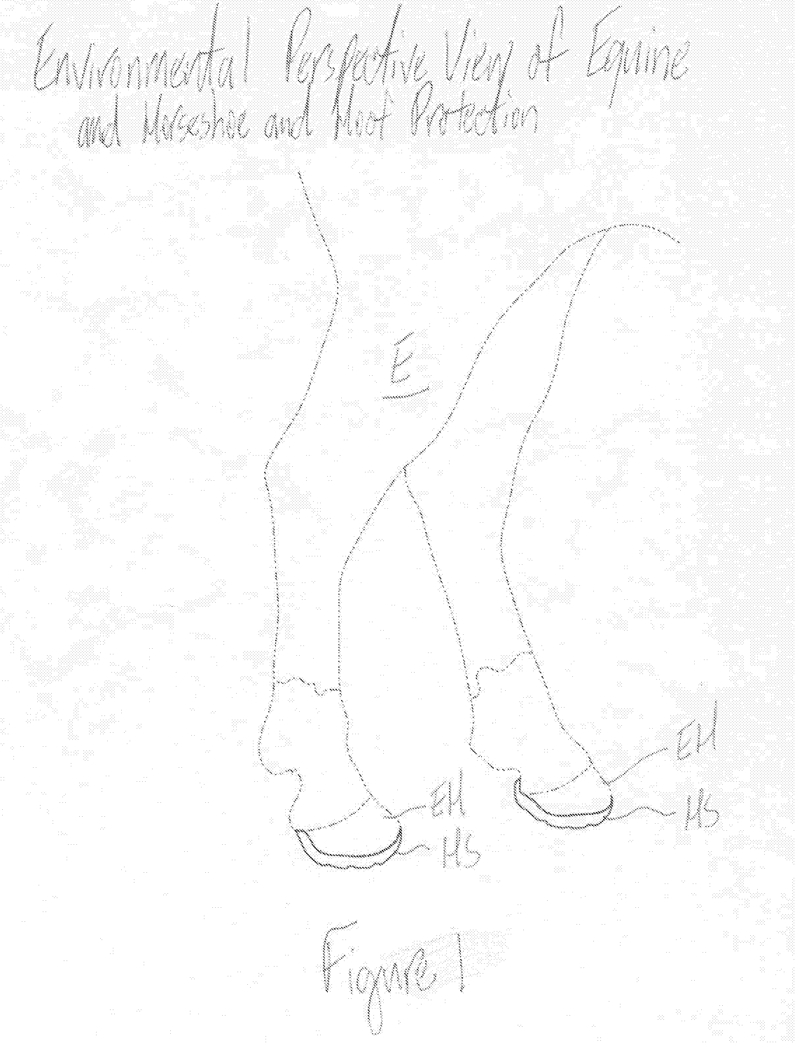

FIG. 1 illustrates an environmental side perspective view of an equine E with an equine hoof EH wearing a horseshoe and hoof protection HS, in accordance with one embodiment of the present invention.

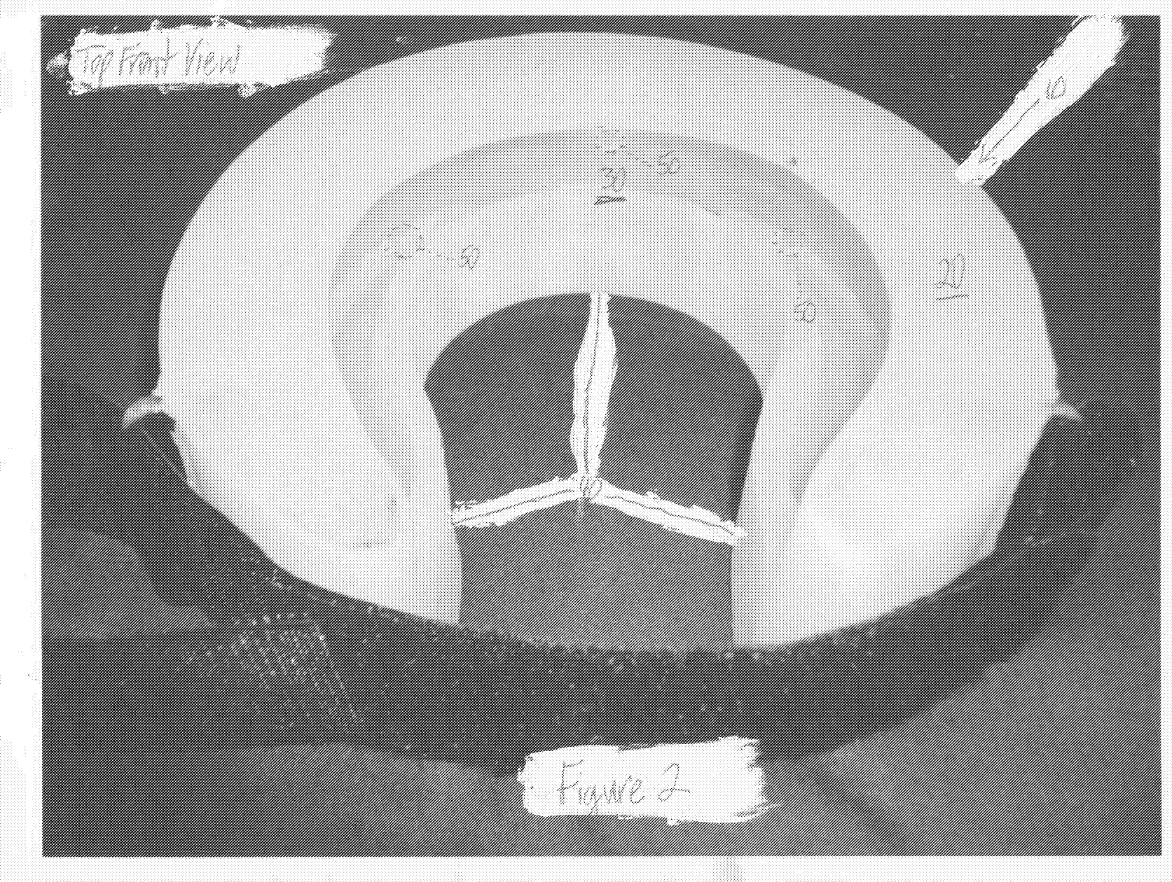

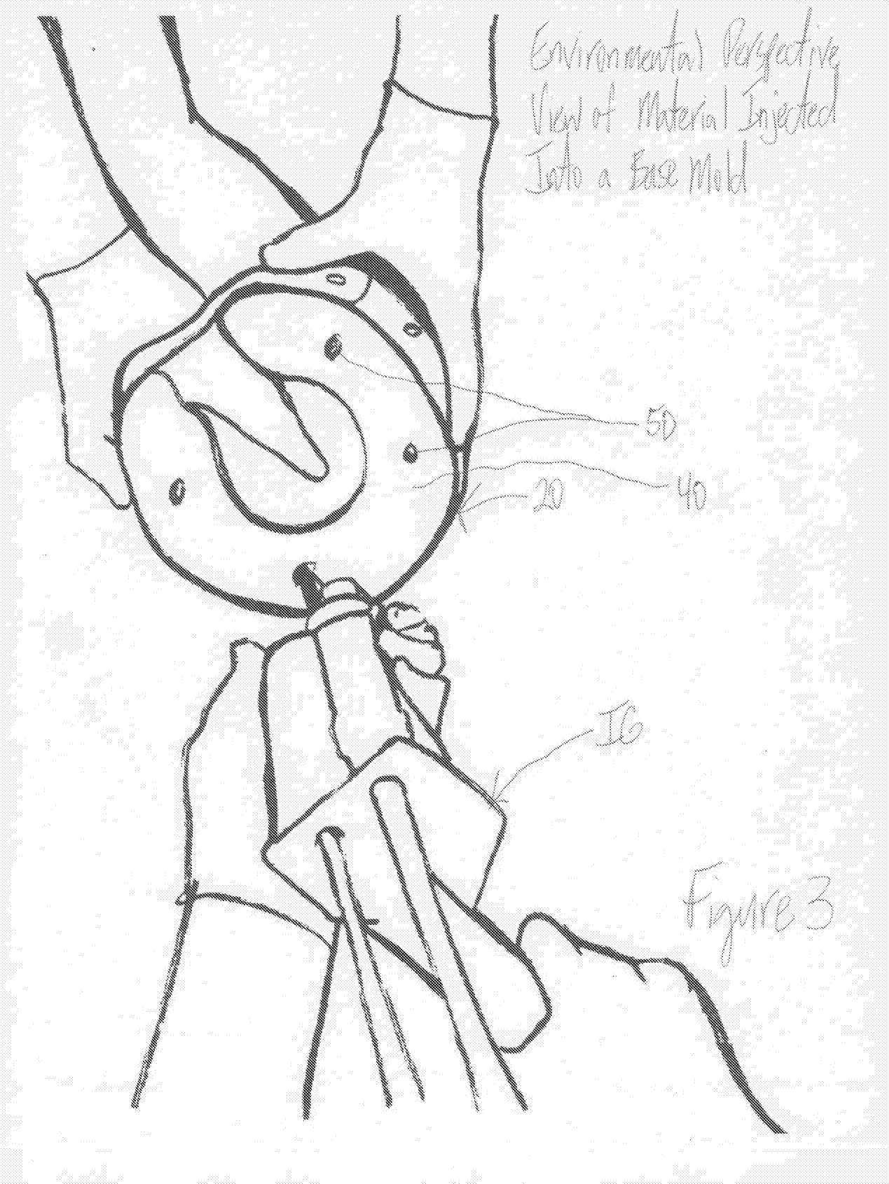

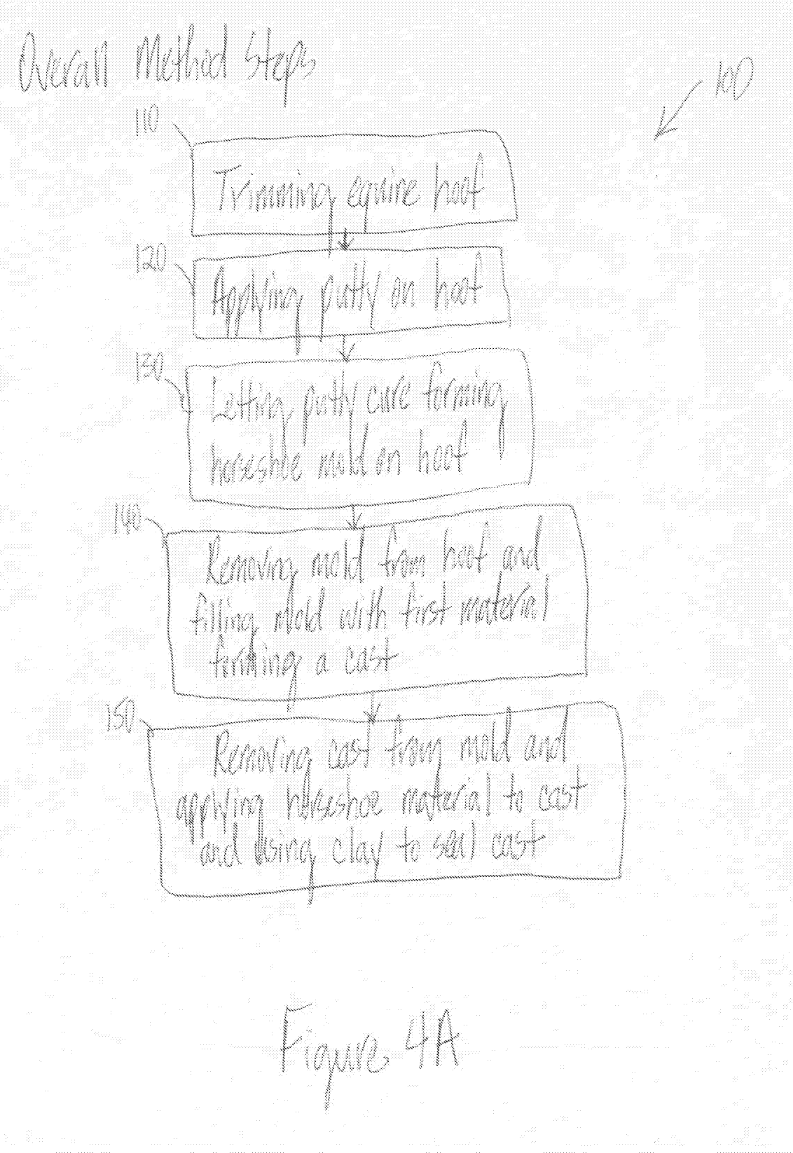

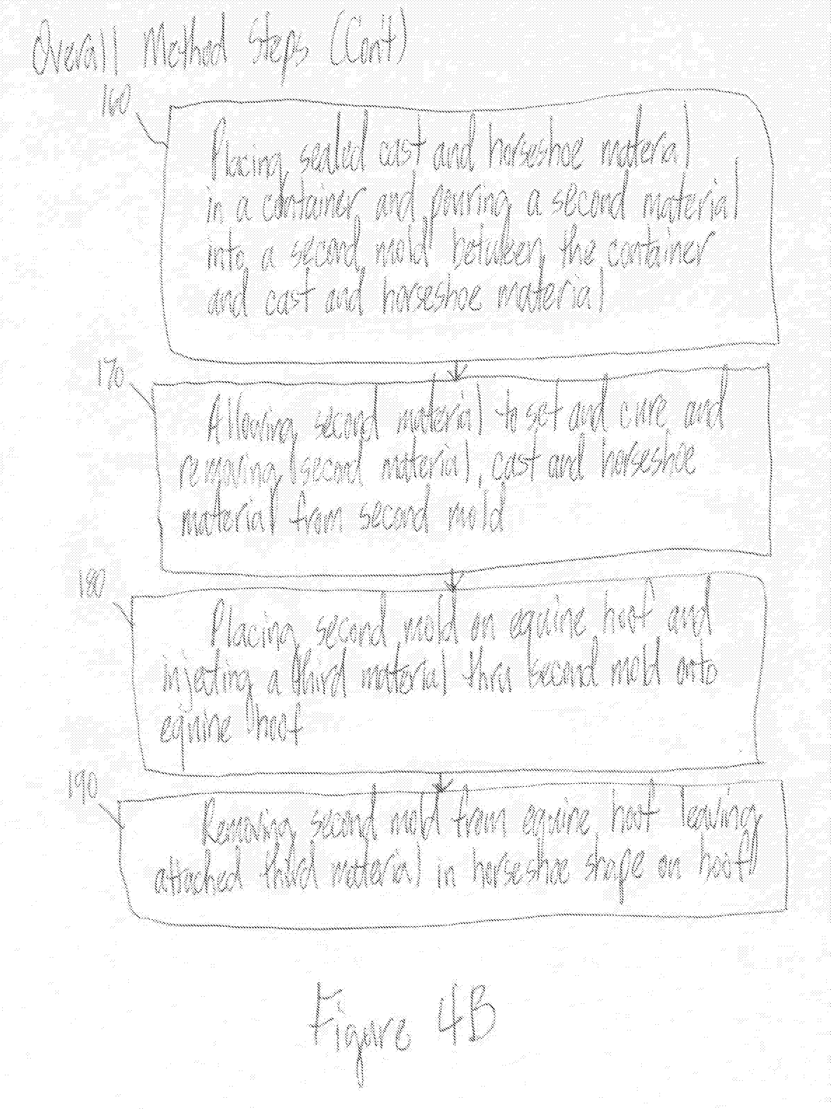

FIG. 2 illustrates a top front perspective view of a mold for an equine E with an equine hoof EH to make an in situ horseshoe and hoof protection 10, in accordance with one embodiment of the present invention. The overall mold 10 has a base mold 20 with a cavity area 30 to accommodate an equine hoof EH with a base in a general horseshoe and hoof protection shape 40. A fast setting material is injected into the cavity area 30 through a plurality of holes 50 when the equine hoof EH is placed in the cavity area 30 forming the horseshoe and hoof protection HS after an increment of time while the injected material cures and sets, as is illustrated in FIG. 3, in accordance with one embodiment of the present invention. The injected material is a two part plastic or urethane and adhesive and the best mode increment of time that the injected material sets and cures is in a range of 1 to 5 minutes. The injected material can be any two part plastic or urethane and adhesive material that is well known to those schooled in the art. The injected material is typically injected by an injection gun IG that is also well known to those schooled in the art, but the mold and method is not limited to the use of an injection gun to inject the material. An optional hinge mechanism can also be utilized (not shown) to facilitate removal of the horseshoe and hoof protection HS from the base mold 20 after the setting and curing of the injected material, as discussed in FIG. 4A and FIG. 4B and the method steps discussed in the FIG. 4A and FIG. 4B description.

The base mold 20 can accommodate the injected material when particles of additional material to increase durability and traction (not shown) are added to the injected material. These particles are placed inside of the base mold 20 before applying the injected material inside the base mold 20. The particles can include tungsten granules and dust and carbide granules and dust, but can include other particles that increase the durability and traction of the horseshoe and hoof protection HS that are well known in the art. A stud thread (not shown) can also be added to the injected material before and during application of the injected material. In addition, a plurality of inserts of material to increase durability (not shown) can also be placed in the base mold 20 before applying the injected material.

The base mold 20 can be manipulated and handled to loosen and release the set and cured horseshoe and hoof protection HS once the injected material is set and cured. The base mold 20 can also incorporate a therapeutic design onto the horseshoe and hoof protection HS, which can include a heart bar design and a straight bar design. The therapeutic design can be any therapeutic design that is well known in the art that is capable of being produced by the base mold 20. The base mold 20 and mold for an equine animal with an equine hoof to make an in situ horseshoe and hoof protection 10 are made of translucent silicon and can also be made of any other plastic material that can be injected into the base mold 20 that is well known in the art.

FIGS. 4A and 4B illustrate a flow chart of the method steps for making and attaching an in situ horseshoe and hoof protection to an equine 100, in accordance with one embodiment of the present invention. The overall method steps include trimming the equine hoof and removing any loose sole, horn and frog 110, applying a two part putty on the hoof bottom, the side walls and the heel bulbs 120, letting the putty cure in situ on the hoof forming the horseshoe mold on the hoof 130, removing the mold from the hoof and filling the mold with a first two part premixed fast setting semi-rigid and rigid material setting inside the mold until solidified, forming a solid cast 140, removing the formed cast from the mold and applying a horseshoe and hoof protection material to the formed cast and using a moldable clay to seal any gaps between the horseshoe and protection material and the formed cast 150, placing the sealed cast and the applied protection material in a container and pouring a second premixed two part material into a second mold formed between the container and the cast and horseshoe material until covering the protection material 160, letting the second material set and cure and removing the second material, the cast and the horseshoe and protection material from the second mold 170, placing the second mold on the equine hoof and injecting a fast setting third material through the second mold and onto the hoof 180 and removing the second mold and leaving the third material in the horseshoe and hoof protection shape attached to the hoof 190.

The first step of the overall method 100 is trimming the equine hoof and removing any loose sole, horn and frog 110. A brush, such as a wire brush, should also be used to brush the hoof clean of any loose debris. The second step of the overall method 100 is applying a two part putty on the hoof bottom, the side walls and the heel bulbs of the equine120. The two part putty is a silicon putty that sets in 1-5 minutes once mixed together with an adequate amount to cover the solar or bottom surface of the hoof and approximately 1-3 inches in height of the putty up the dorsal or side wall and the heel bulbs of the hoof.

The purpose of this is to let the putty set and cure in situ on the hoof until it is a solid silicon rubber 130, which is the third step of the overall method 100. The rubber will produce a perfect mold of the applied hoof. The mold is then removed and filled with a two part premixed fast setting semi-rigid or rigid urethane to a depth of 1-4 inches depending on the mold's shape and size 140, which is the fourth step of the overall method 100. This material sets inside the mold created until it is a solid plastic cast. This solid plastic cast is removed from the hoof mold and is an exact replica of the hoof applied. A horseshoe shape or hoof covering made of any material and of any shape is also applied to this cast and a moldable clay is used to seal any gaps between the horseshoe or hoof covering and the hoof cast 150, which is the fifth step of the overall method 100. The horseshoe and moldable clay are prepared for molding by adding clay in the center and at various points of the prepared horseshoe on the hoof cast. The purpose of this moldable clay is to provide depth to the mold when placed in a container, as discussed in the sixth step 160. The additional purpose of the points of clay added, are for a plurality of injection holes on the finished product.

The hoof cast and prepared hoof covering or horseshoe is placed in the container and a second material of a two part urethane or silicone liquid rubber that was premixed is poured into a second mold formed between the container and cast and horseshoe material 160, which is the sixth step of the overall method 100. The second material is poured until it covers the pre-made hoof covering or horseshoe up to an approximate distance of 1-3 inches in height within the container and shouldn't fill past the hoof cast. The urethane or silicon liquid is allowed to set and cure until it is firm and the material is removed from the second mold along with the hoof cast and horseshoe or hoof covering 170, which is the seventh step of the overall method. This second mold is the final product of the overall method, for the purpose of making an in situ horseshoe or hoof covering mold for an equine hoof 100. The in situ horseshoe is made when the constructed mold is placed in position on the equine hoof and a fast setting urethane, which is a third material, is injected through the mold 180, which is the eighth step of overall method 100. Once this fast-set urethane has set to a solid state, the second mold is removed from the equine hoof leaving attached the third material in a horseshoe shape on the equine hoof 190, which is the ninth and final step of the overall method 100.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

What is claimed is:

1. A flexible one-piece horseshoe plastic mold for an equine animal with an equine hoof to make an in situ horseshoe and hoof protection to protect said equine hoof, comprising:
a base mold with a cavity area to accommodate said equine hoof with a base in a general horseshoe and hoof protection shape;
a fast setting material injected into said cavity area through a plurality of holes when said equine hoof is placed in said cavity area forming said horseshoe and hoof protection after an increment of time while said injected material cures and sets while said hoof is placed in said cavity; and
a optional hinge mechanism to facilitate removal of said horseshoe and hoof protection from said base mold after said setting and curing.

2. The mold according to claim 1, wherein said material is a two part plastic, urethane and adhesive.

3. The mold according to claim 1, wherein said increment of time said material sets and cures is in a range of 1 to 5 minutes.

4. The mold according to claim 1, wherein particles of material to increase durability and traction are added to said injected material.

5. The mold according to claim 4, wherein said particles are placed inside of said mold before applying said injected material.

6. The mold according to claim 5, wherein said particles are tungsten granules and dust and carbide granules and dust.

7. The mold according to claim 1, wherein a stud thread is added to said injected material before and during application of said injected material.

8. The mold according to claim 1, wherein a plurality of inserts of material to increase durability are placed in said mold before applying said injected material.

9. The mold according to claim 1, wherein said mold can be manipulated and handled to loosen and release said set and cured horseshoe and hoof protection.

10. The mold according to claim 1, wherein said mold incorporates a therapeutic design onto said horseshoe and hoof protection.

11. The mold according to claim 10, wherein said therapeutic design is a heart bar design and a straight bar design.

12. The mold according to claim 1, wherein said mold is made of translucent silicon, a clear plastic material and a translucent plastic material.

13. A method of making and attaching an in situ horseshoe and hoof protection to an equine to accommodate an equine hoof with a sole, a horn, a frog, a plurality of side walls, a plurality of heel bulbs and a bottom with a base in a general horseshoe and hoof protection shape, comprising the steps of:
trimming said equine hoof and removing any loose said sole, said horn and said frog;
applying a two part putty on said hoof bottom, said side walls and said heel bulbs;
letting said putty cure in situ on said hoof forming said horseshoe material mold on said hoof;
removing said mold from said hoof and filling said mold with a first two part premixed fast setting semi-rigid and rigid material setting inside said mold until solidified, forming a solid cast;
removing said formed cast from said mold and applying a horseshoe and hoof protection material to said formed cast and using a moldable clay to seal any gaps between said horseshoe and protection material and said formed cast;
placing said sealed cast and said applied horseshoe protection material in a container and pouring a second premixed two part material into a second mold formed between said container and said cast and horseshoe material until covering said protection material;
letting said second material set and cure and removing said second material, said cast and said horseshoe and horseshoe protection material from said second mold;
placing said second mold on said equine hoof and injecting a fast setting third material through said second mold and onto said hoof; and
removing said second mold and leaving said third material in said horseshoe and hoof protection shape attached to said hoof.

14. The method according to claim 13, wherein said trimming includes brushing said hoof, said sole, said horn and said frog clean.

15. The method according to claim 13, wherein said putty is silicon putty.

16. The method according to claim 13, wherein said first material is urethane.

17. The method according to claim 13, wherein said clay in said applying step is applied to a center area of said mold and in a plurality of injection holes within said mold.

18. The method according to claim 13, wherein said poured second material is filled before covering said hoof cast.

19. The method according to claim 18, wherein said second material is urethane and silicone.

20. The method according to claim 13, wherein said third material is urethane.
